(19) United States
(12) Patent Application Publication
(10) Pub. No.: US 2024/0051844 A1
(43) Pub. Date: Feb. 15, 2024

(54) FLUID FILTRATION SYSTEM AND METHOD

(71) Applicant: ZF Friedrichshafen AG, Friedrichshafen (DE)

(72) Inventors: Fernando BERA, Simpsonville, SC (US); Prithviraj RAO, Greenville, SC (US); Anderson Gomes da SILVA, Simpsonville, SC (US); Sameer SANGVIKAR, Simpsonville, SC (US)

(73) Assignee: ZF Friedrichshafen AG, Friedrichshafen (DE)

(21) Appl. No.: 18/364,769

(22) Filed: Aug. 3, 2023

Related U.S. Application Data
(60) Provisional application No. 63/397,516, filed on Aug. 12, 2022.

(51) Int. Cl. C02F 1/00

(52) U.S. Cl. CPC C02F 1/004; C02F 2101/32

(57) ABSTRACT

Disclosed herein is a system and method for treating fluids from wash and rinse tanks that are used to remove metalworking fluids and particles from industrial parts. The process allows for the reuse of substantially all of the fluids, can be automated, reduces microbial growth and provides for cleaner industrial parts with reduced use of cleaner. Specific applications include automotive parts.

### BACKGROUND

The manufacturing of metal and alloy parts often requires the use of metalworking fluids to cool and lubricate the parts during production. These metalworking fluids can be petroleum based or synthetic materials. Metalworking fluids need to be cleaned from parts during various stages of the manufacturing process. Solvent based cleaning systems have given way to aqueous based systems that are safer in the workplace. However, aqueous cleaning systems present other issues, such as the separation of non-aqueous fluids from the water-based cleaning system after the parts have been washed.

### SUMMARY OF THE INVENTION

In one embodiment, a process for treating a fluid used to wash machined parts is provided, the process comprising flowing a fluid from a wash tank or a rinse tank to a first chamber of a filtration tank, the fluid comprising water, a non-aqueous phase, and metallic particles, removing at least a portion of the non-aqueous phase from an upper layer of the fluid in the first chamber, flowing the fluid to a second chamber of the filtration tank and separating metallic particles from the fluid, separating the fluid into a first fluid stream and a second fluid stream, flowing the first fluid stream through a particle filter, flowing the first fluid stream through a membrane filter, combining the first fluid stream and the second fluid stream to produce a combined stream, and flowing the combined stream to the wash tank or rinse tank from which the fluid was removed.

In a second embodiment greater than 60% to 95% of the aqueous portion of the fluid flowed from the wash tank or rinse tank is returned to the wash tank or rinse tank without adding makeup fluid. In a third embodiment the ratio of the flow rate of second fluid stream to the flow rate of the first fluid stream is greater than 10:1. In embodiment 4, the volume of the wash tank or rinse tank is turned over in less than 15 mins, less than 30 mins or less than 60 mins. In embodiment 5 the concentration of non-aqueous material (oil) in the combined stream is less than 10% of the concentration of non-aqueous material in the wash or rinse tank fluid. In embodiment 6 the concentration of solid particulates in the combined stream is less than 10% of the concentration of solid particulates in the wash or rinse tank fluid. In embodiment 7 removing comprises storing removed non-aqueous phase in a waste receptacle. In embodiment 8 the process includes removing particles from the fluid by flowing the fluid through a mesh screen prior to separating the fluid into first and second fluid streams. In embodiment 9 at least a portion of the non-aqueous phase is emulsified in the water phase. In embodiment 10 at least a portion of the filtration tank is heated to greater than 60° C. In embodiment 11 the tank is a wash tank and the process of the claim is also applied in parallel to a rinse tank. In embodiment 12 the wash tank process and the rinse tank process are isolated. In embodiment 13 the wash tank and rinse tank processes are isolated but share a common waste receptacle. In embodiment 14 the process includes separation of the metallic particles by gravity separation.

### BRIEF DESCRIPTION OF THE DRAWINGS

The above-mentioned and other features of this disclosure, and the manner of attaining them, will become more apparent and better understood by reference to the following description of embodiments described herein taken in conjunction with the accompanying drawings, wherein:

FIG. 1 is a process diagram of one embodiment of a fluid treatment system;

FIG. 2 is a process diagram of another embodiment of a fluid treatment system;

FIG. 3 is a table showing the reduction in oil concentration using one embodiment of the process;

FIG. 4 is a table showing the reduction in particulate concentration using the embodiment of FIG. 3.

FIG. 5 provides particulate analysis of untreated rinse fluid;

FIG. 6 provides particulate analysis of untreated wash fluid,

FIG. 7 provides particulate analysis of combined fluid that has been initially treated using one embodiment; and

FIG. 8 provides particulate analysis of fluid that has been treated using a two stage process of one embodiment.

### DETAILED DESCRIPTION

Milling, turning, cutting and other machining procedures often require the use of metalworking lubricants such as cutting oils, threading oils, broaching oils and quenching oils. As used herein, a metalworking lubricant or metalworking fluid is a fluid that is used during a metal working process to cool and or lubricate the part being machined or the tool being used. These metalworking fluids can be petroleum based or can be synthetic compounds such as synthetic esters. The metalworking fluids can be insoluble, partially soluble, or dispersible in water.

At various stages of the metalworking process parts may need to be washed of metalworking fluids and particulate matter that has gathered on the part. Environmental and safety requirements have led to the use of aqueous based washing systems. As parts are washed or rinsed, the wash fluid retains metalworking fluids and particles, and the wash fluid must be replaced or regenerated to continue effective washing. Bacterial growth can also occur if the wash fluid is not sanitized or replaced regularly. By removing metalworking fluid and particles from the used wash fluid, the wash fluid can be reused, and the isolated metalworking fluid and particles can be disposed of or recycled.

Some metalworking fluids and their breakdown products can be difficult to remove from aqueous wash fluids. Metalworking fluids can become dispersed or emulsified in the wash fluid making it difficult to separate the metalworking fluid from the wash fluid. The methods and systems described herein provide an efficient, automated, safe method for recycling wash fluid in industrial wash and rinse tanks. The methods can provide a fast flow rate of returned wash or rinse fluid and can prolong the number of times that a wash fluid can be used. In some embodiments, the majority of organic material is removed from the wash and then the wash is split into two streams, one of which is subjected to fine particle and organic compound reduction and a second which can be directed back to the wash or rinse tank without additional organic or particle reduction.

The process can be automated and controlled by a microprocessor with an HMI that allows the operator to monitor and run the system. Sensors such as thermocouples, pressure gauges, valve position sensors, flow rate sensors, load cells and conductivity sensors can be placed throughout the system and can communicate with the microprocessor. For example, the waste receptacle may be on a scale (load cell) that reports when the receptacle is full or a predetermined percentage full. For instance, when the receptacle reaches 80% capacity an email can be sent to an operator, an audio signal may be activated, or a condition visually indicated on the HMI. The system can also be programmed to decrease or increase flow rates depending on the quality of incoming or outgoing fluids. For instance, if incoming fluid shows an increasing oil content (e.g., by turbidity or conductivity) the flow rate can be increased. In other cases, if the fluid being returned to the industrial washer should start to decrease in quality, the system flow rate can be reduced, or the ratio of bypass fluid to filtered fluid can be changed.

The processes described herein can be used with a variety of wash fluids used to remove various metalworking fluids and particulate matter. Examples used herein are directed to the washing of machined parts such as those used to produce automotive transmissions. One example of a metalworking fluid used in transmission parts production is a broach oil, such as Isocut BA 5 ZF, available from Petrofer. This broach oil includes both non-aqueous organic compounds as well as organic salts. Specifically, Isocut BA 5 ZF includes hydrotreated petroleum distillates, alkylbenzene sulfonate, triarylphosphate, alkaline earth sulfonate and an amine salt of phosphoric acid esters. Aqueous wash fluids can include cleaning agents, derusters and preservatives in addition to water. An example of a cleaning agent is Bonderite C-NE N, available from Henkel. This material is typically used at a concentration of 3 to 10% by volume in water. An example of a surface passivation agent is Bonderite S-FN 6748, also available from Henkel. Bonderite S-FN 6748 is a surface passivation agent that helps prevent corrosion of ferrous parts during storage. It is typically used at 0.5 to 3% in the wash fluid, and the wash fluid can be titrated to determine when additional preservative needs to be added.

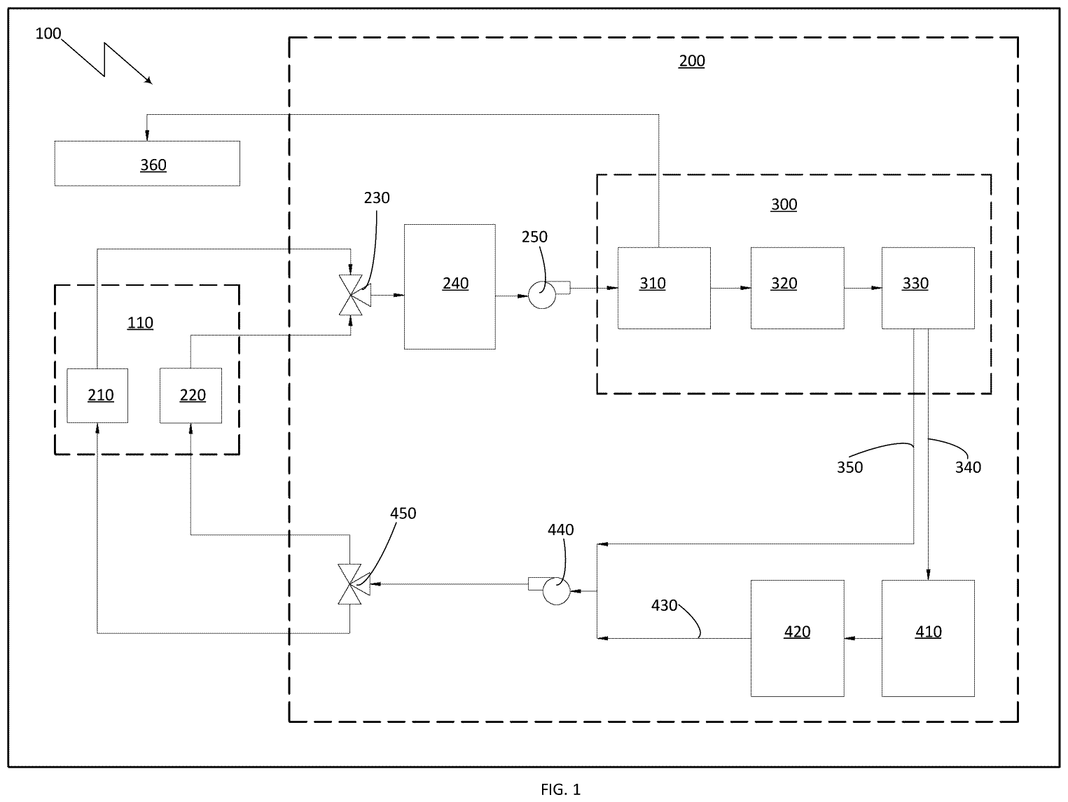

FIG. 1 provides a schematic drawing of one embodiment of the process disclosed herein. System 100 includes industrial washer 110 that can be, for example, wash tank 210 and/or rinse tank 220. Either or both of wash tank 210 and rinse tank 220 may include ultrasonic cleaners for aiding in removal of material from parts. In one set of embodiments, the bulk of metalworking fluid and particles are removed in wash tank 210 and then finished in rinse tank 220. Depending on which tank is being cleaned, either wash fluid or rinse fluid is flowed from wash tank 210 or rinse tank 220 and directed to filtration system 200 via valve 230. The fluids may be drawn from the top, bottom or middle of the tank and in the embodiment shown the fluids are drawn from the top of the tank. As wash and rinse fluid may contain different substances, they are typically treated separately, and are passed through the same system at different times. Portions or all of filtration system 200 can be heated to destroy microbes that may grow in the wash/rinse fluid. In this embodiment, material is flowed at a rate of about 28 L/m. From valve 230 the flow from the wash or rinse tank is passed through a screen 240 having a mesh size of 16 to remove large particles and chunks of metal. Filtration tank 300 includes first chamber 310, second chamber 320 and third chamber 330. After passing through strainer screen 240, the fluid (mixture of water, chemicals and metalworking fluids) passes through pump 250 and enters separator first chamber 310 that includes a separator apparatus. In this particular embodiment, the separator apparatus is a cone that receives lighter phase material from the top portion of the column of liquid in the chamber. In this case, the lighter, floating material is primarily used metalworking fluid and other organic material. This organic material is shuttled to waste drum 360. When waste drum 360 is full, the material can be disposed of or recycled for additional use. After lighter phase material is removed in chamber 310, the wash/rinse fluid is flowed to second chamber 320 where denser solids, such as metal particles, are separated by gravity separation. Third chamber 330 acts as the staging chamber for the fluid to be pumped into the next stages of treatment.

After passing through the third chamber 330, the wash/rinse fluid is split into two streams. The stream is split and pumped back to the tank to enhance the effectiveness and volume flow rate of the filtration process. The ratio between the flow rate through 340 to the flow rate through 350 can be between 1:10 to 1:20, 1:5 to 1:10, 1:10 to 1:50 or 1:5 to 1:50. This ratio can be adjusted in response to system inputs. First stream 340 is flowed to bag filter 410 where particles larger than 100 μm are removed. First stream 340 then proceeds to membrane filter 420 where the membrane removes materials such as emulsified oil, bacteria, colloids and finer particulates that were not previously removed. After passing across membrane filter 420, first stream 340 is rejoined with second stream 350 which is flowed directly from third chamber 330. Note that fluid in the first stream 340 will contain fewer contaminants than fluid in the second stream 350. The combined stream passes through pump 440 and is shuttled by 3-way valve 450 to either wash tank 210 or rinse tank 220, depending on where the fluid was drawn from. For example, if valve 230 is drawing from wash tank 210, then valve 450 directs cleaned fluid to wash tank 210.

First chamber 310 and second chamber 320 combined typically remove 90 to 95% of the oil from a wash stream and 80 to 85% of the oil from a rinse stream. After treatment with bag filter 410 and membrane filter 420, the stream 430 typically has an oil concentration that is less than 2% of the original oil concentration in the fluid being drawn from the wash tank or rinse tank. The solid particulate content is greatly reduced by the filtration process. First chamber 310 and second chamber 320 combined typically remove 90 to 95% of the solid particulates from a wash stream and similarly 90 to 95% from a rinse stream. After treatment with bag filter 410 and membrane filter 420, the solid particulate content in stream 430 typically has a concentration that is less than 2% of the original solid particulates in the fluid being drawn from the wash tank or rinse tank.

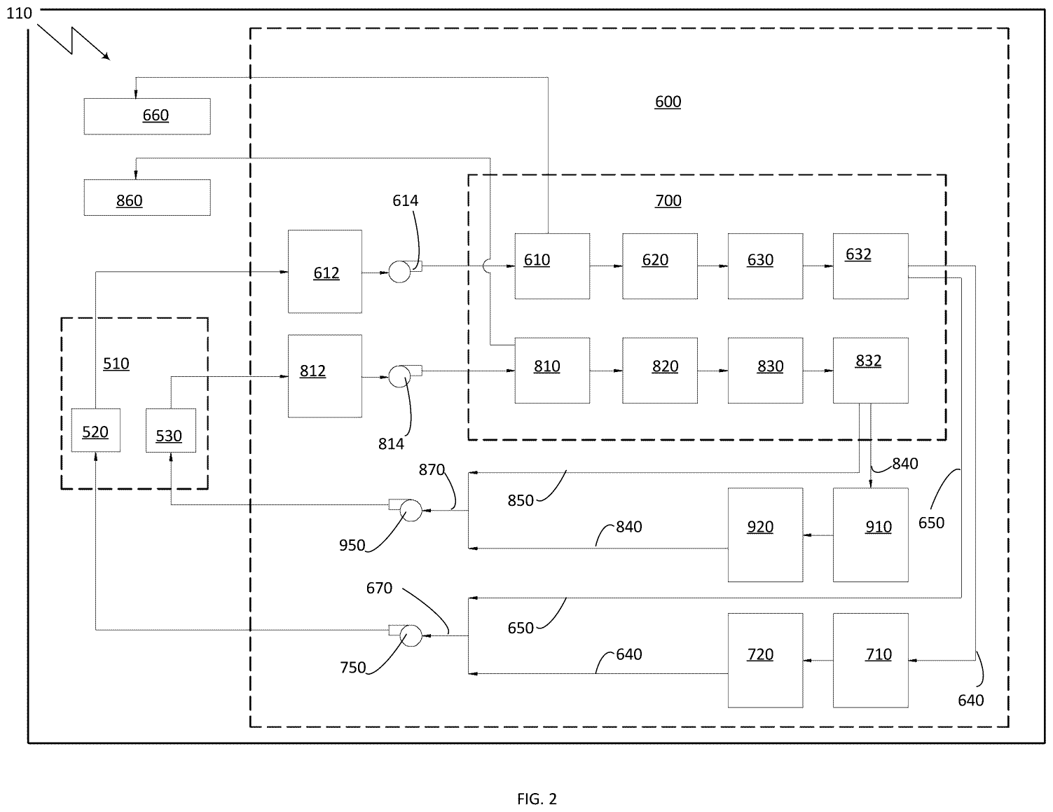

The parallel systems shown in FIG. 2 can provide additional efficiencies to the system shown in FIG. 1. For instance, while being able to process fluids simultaneously, the parallel systems require less than double the space of the single system of FIG. 1. For example, the filtration system with tank 700 can have a footprint that is less than 150% of the footprint of a system with tank 300. As mentioned above, the parallel systems can share a common waste receptacle that takes up only as much space as the waste receptacle in FIG. 1. In addition, while a higher level of organic and particle passthrough may be acceptable for the wash tank, with parallel systems the rinse tank fluid is treated to a higher level of purity resulting in a cleaner rinse tank, resulting in cleaner parts after rinse. As a result, filters in the wash tank fluid circuit may be left in place longer than if they needed to filter rinse tank fluid as well.

Although the two circuits of FIG. 2 are fluidly isolated from each other, they can still share parts or modules that save on manufacturing and production costs. For instance, the filtration machine tank can use a single heater for heating and disinfecting both loops. Common control systems such as controllers, HMI and other electricals utilities can be used. There are also fewer 3-way valves required because the lines are dedicated to either the wash tank circuit or the rinse tank circuit. Furthermore, one circuit can be serviced, e.g., membranes changed, or strainers emptied while the other circuit remains in service. By avoiding switching the system from tank to tank there is also less monitoring and input required by the operator.

System 110 includes two separate but parallel purification systems that independently treat wash fluid and rinse fluid. Independent systems mean that there is no cross-contamination between the fluids and that both the wash and rinse tanks can be treated simultaneously. Although two waste receptacles, 660 and 860, are shown, in other embodiments the two systems can feed oily waste to a common waste receptacle.

Industrial washer 510 can include a wash tank 520 and a rinse tank 530 and can include more than one of each. Wash tank 520 typically will have a heavier load of non-aqueous organic material as well as particulate matter and thus will produce more waste. As a result, although the components of each treatment loop may be the same, the wash tank loop may remove more impurities than does the rinse loop. For example, waste receptacle 660 may fill more quickly than waste receptacle 860, and bag filters and membrane filters may need to be serviced more often in the wash loop.

Strainer 612 can be positioned inline between wash tank 520 and pump 614 that feeds wash fluid to filtration machine tank 700. Fluid can be drawn from the wash tank at the upper half of the tank. After entering filtration machine tank 700, the first treatment the fluid receives is in oil removal chamber 610 that removes the bulk of the low density non-aqueous material that has gathered at the top of the column. The oil layer is passed to waste receptacle 660 while the bulk of the aqueous fluid passes to second chamber 620 where heavier particles are removed by gravity separation. In third chamber 630, additional particles of varying densities are strained out before the fluid is passed on to staging chamber 632. By the time the fluid reaches staging chamber most of the oil and particles have been removed. At this point, the outflow can be split into streams 640 and 650 by a valve, restrictors or pumps, for example. The stream is split and pumped back to the tank to enhance the effectiveness and volume flow rate of the filtration process. The ratio between the flow rate through 340 to the flow rate through 350 can be between 1:10 to 1:20, 1:5 to 1:10, 1:10 to 1:50 or 1:5 to 1:50. This ratio can be adjusted in response to system inputs. Stream 640 passes through bag filter 710 to remove remaining larger particulates (greater than 100 μm) and then through membrane filter 720 that is capable of removing, for example, emulsified oil, bacteria, colloids and other particulates that have not been removed by upstream treatment. The stream is split and pumped back to the tank to enhance the volume flow rate of the treatment process.

Stream 640 is reunited with stream 650 to form common stream 670 that is pumped through pump 750 and back to wash tank 520. Make up fluid can be added to stream 670 if necessary, but most or all of the usable wash fluid is returned to the wash tank.

The circuit for the rinse fluid loop can function in an analogous manner to treat rinse fluid. Strainer 812 can be positioned inline between rinse tank 530 and pump 814 that in turn feeds rinse fluid to filtration machine tank 700. Fluid can be drawn from the rinse tank at the upper half of the tank. After entering filtration machine tank 700, the first treatment the fluid receives is in oil removal chamber 810 that removes the bulk of the low density non-aqueous material that has gathered at the top of the liquid column. The oil layer is passed to waste receptacle 860 while the bulk of the aqueous fluid passes to separation chamber 820 where heavier particles are removed by gravity separation. In strainer chamber 830, additional particles of varying densities are strained out before the fluid is passed on to staging chamber 832. By the time the fluid reaches staging chamber 832 most of the oil and particles have been removed. At this point, the outflow can be split into streams 840 and 850 by a valve, flow restrictors, or pumps, for example. The stream is split and pumped back to the tank to enhance the effectiveness and volume flow rate of the filtration process. The ratio between the flow rate through 340 to the flow rate through 350 can be between 1:10 to 1:20. This ratio can be adjusted in response to system inputs. Stream 840 passes through bag filter 910 to remove remaining larger particulates (greater than 100 μm) and then through membrane filter 920 that is capable of removing, for example, emulsified oil, bacteria, colloids and other particulates that have not been removed by upstream treatment. Stream 840 is reunited with stream 850 to form common stream 870 that is pumped through pump 950 and back to rinse tank 530. Make up fluid can be added to stream 870 if necessary, but most or all of the usable rinse fluid is returned to the rinse tank.

### Examples

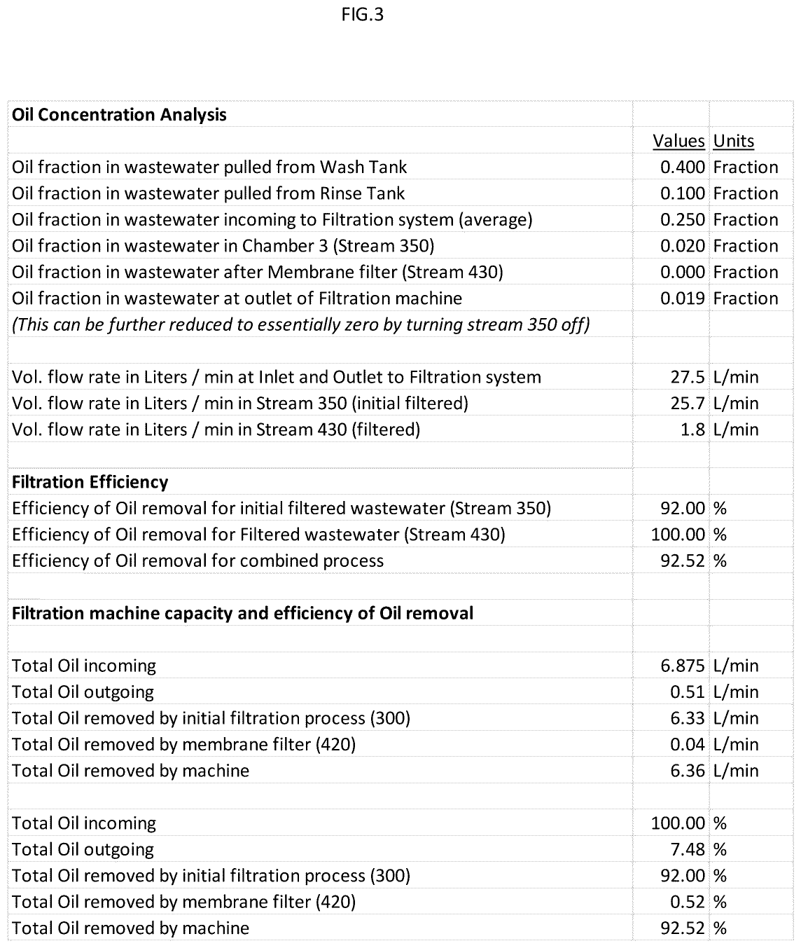

FIGS. 3-8 illustrate the results of fluid treatment using the system of FIG. 1. The samples treated and analyzed were real world samples from wash and rinse tanks that were used to wash parts that had been machined using Isocut BA 5 ZF. Each of the wash tank and the rinse tank hold 190 gallons of fluid for a total of 380 gal (1438 liters). The system was operated at a rate of 27.5 L/min with equal rates of fluid being drawn from the rinse and wash tanks.

FIG. 3 provides results for the oil (non-aqueous phase) content of the fluid stream at various points during the treatment process. Equal flow rates were pulled from each of the wash and rinse tanks (from top), so that the combined stream was about ¼ oil by volume. The initial treatment in section 300 resulted in a reduction in the oil fraction (stream 350) to about 1/50^{th} oil, by volume. The concentration of oil in the membrane treated stream (430) was undetectable. Overall, the process resulted in removal of 92.52% of the oil originating from the combined rinse and wash tank stream.

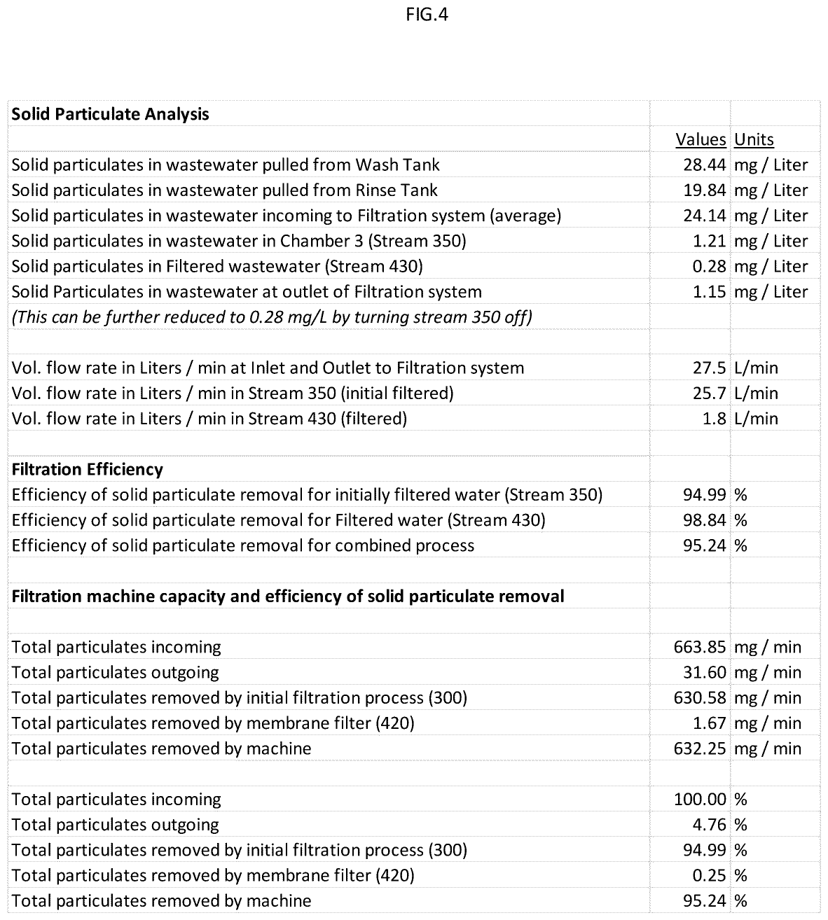

FIG. 4 provides the same data for particulate removal. The initial particulate concentration of the combined stream from the wash and rinse tanks was 24.14 mg/L of solid particulates. After initial filtration (350) the concentration was reduced to 1.21 mg/L. Analysis of the stream post membrane (430) showed a reduction to 0.28 mg/L. The combined stream being fed back to the wash and rinse tanks contained 1.15 mg/L. With a flow rate of 27.5 L/m through the system, the process was able to remove 632.25 mg/min of particulate matter.

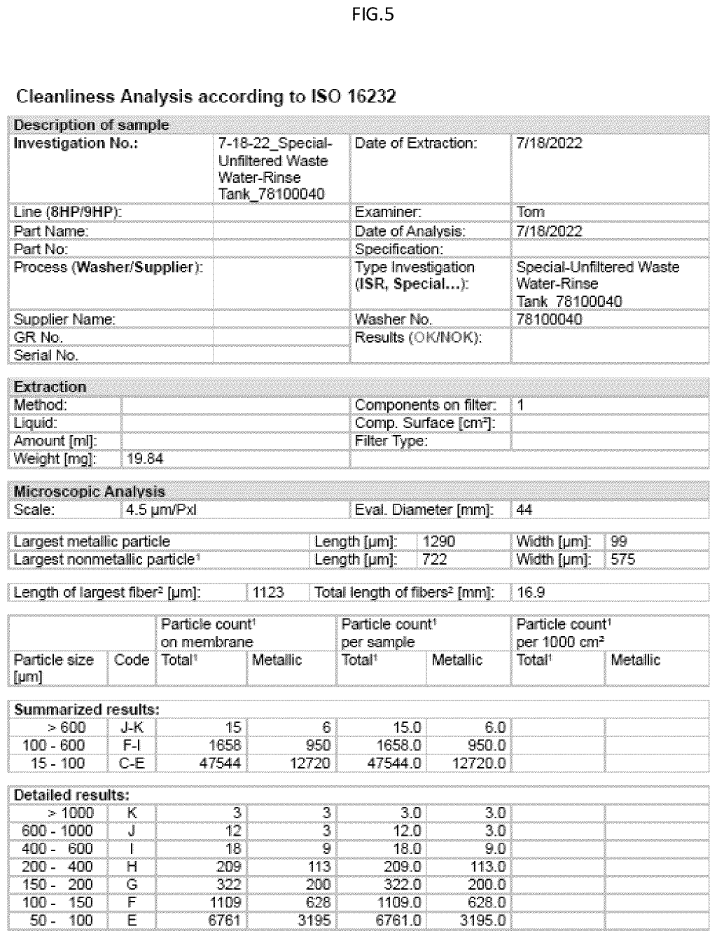

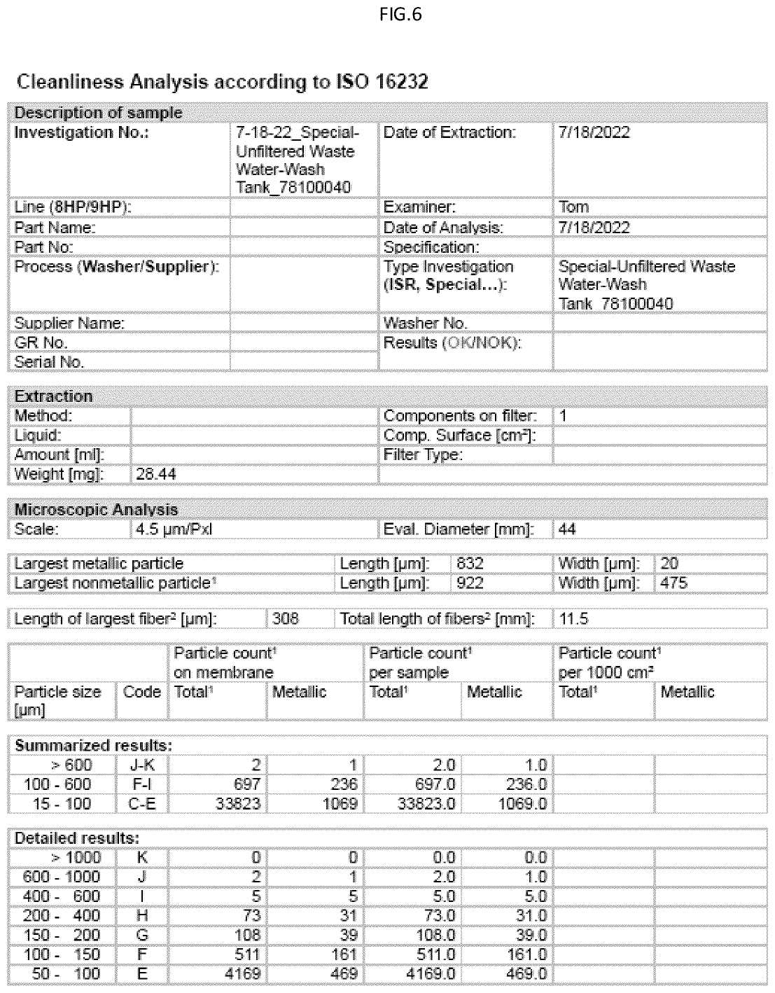

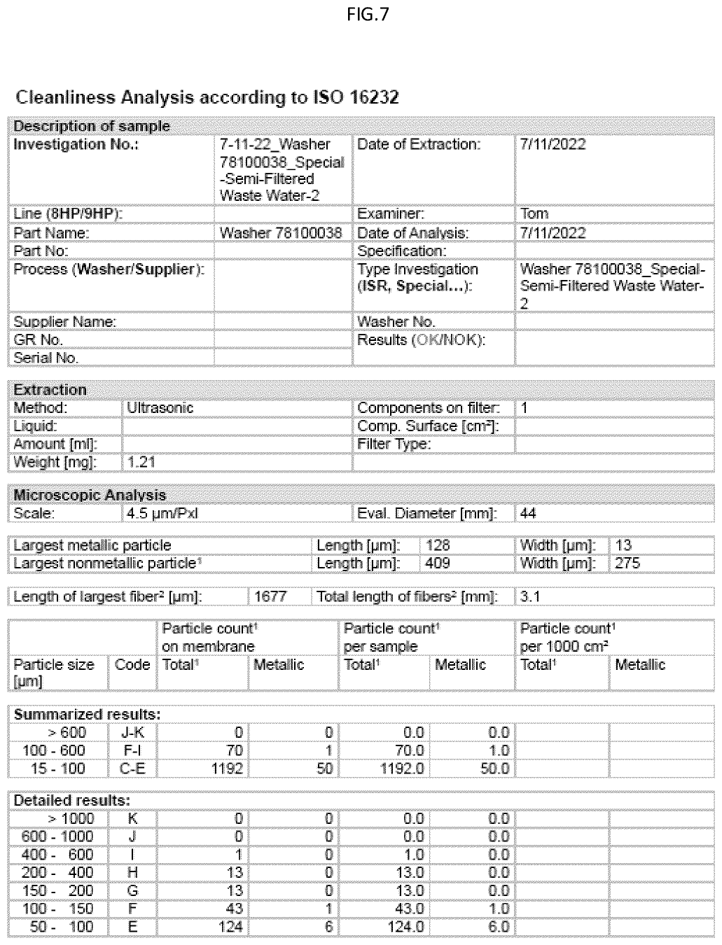

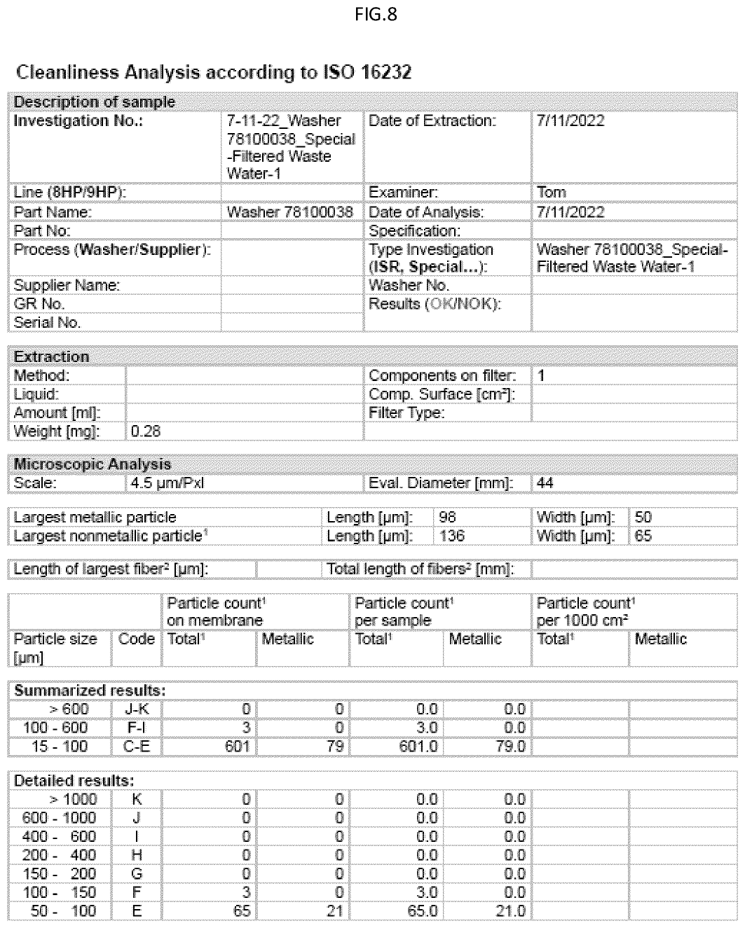

FIGS. 5-8 provide data for streams from various points of the process. Analysis was performed using the protocols of ISO method 16232. FIG. 5 provides particulate results from 1 liter of untreated fluid from the rinse tank. FIG. 6 provides particulate results from 1 liter of untreated fluid from the wash tank. FIG. 7 provides particulate results from 1 liter of fluid from stream 350 that has been initially treated through section 300. FIG. 8 provides particulate results from 1 liter of fluid from stream 430 that has been treated through membrane 420.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

All references, patents and patent applications and publications that are cited or referred to in this application are incorporated in their entirety herein by reference.

1. A process for treating a fluid used to wash machined parts, the process comprising:
flowing a fluid from a wash tank or a rinse tank to a first chamber of a filtration tank, the fluid comprising water, a non-aqueous phase, and metallic particles;
removing at least a portion of the non-aqueous phase from an upper layer of the fluid in the first chamber;
flowing the fluid to a second chamber of the filtration tank and separating metallic particles from the fluid;
separating the fluid into a first fluid stream and a second fluid stream;
flowing the first fluid stream through a particle filter;
flowing the first fluid stream through a membrane filter;
combining the first fluid stream and the second fluid stream to produce a combined stream; and
flowing the combined stream to the wash tank or rinse tank from which the fluid was removed.

2. The process of claim 1 wherein greater than 60% to 95% of the aqueous portion of the fluid flowed from the wash tank or rinse tank is returned to the wash tank or rinse tank without adding makeup fluid.

3. The process of claim 1 or 2 wherein the ratio of the flow rate of second fluid stream to the flow rate of the first fluid stream is greater than 10:1.

4. The process of claim 1 wherein the volume of the wash tank or rinse tank is turned over in less than 15 minutes.

5. The process of claim 1 wherein the concentration of non-aqueous material (oil) in the combined stream is less than 10% of the concentration of non-aqueous material in the wash or rinse tank fluid.

6. The process of claim 1 wherein the concentration of solid particulates in the combined stream is less than 10% of the concentration of solid particulates in the wash or rinse tank fluid.

7. The process of claim 1 wherein removing comprises storing the removed non-aqueous phase in a waste receptacle.

8. The process of claim 1 further comprising removing particles from the fluid by flowing the fluid through a mesh screen prior to separating the fluid into the first and the second fluid streams.

9. The process of claim 1 wherein at least a portion of the non-aqueous phase is emulsified in the water phase.

10. The process of claim 1 wherein at least a portion of the filtration tank is heated to a temperature greater than 60° C.

11. The process of claim 1 wherein the tank is a wash tank and the process of the claim is also applied in parallel to a rinse tank.

12. The process of claim 10 wherein the wash tank process and the rinse tank process are isolated.

13. The process of claim 10 wherein the wash tank and rinse tank processes are isolated but share a common waste receptacle.

14. The process of claim 1 wherein the process includes separation of the metallic particles by gravity separation.

15. The process of claim 1 wherein the volume of the wash tank or rinse tank is turned over in less than 30 minutes.

16. The process of claim 1 wherein the volume of the wash tank or rinse tank is turned over in less than 60 minutes.

17. The process of claim 1 wherein the tank is a wash tank.
